(19) United States
(12) Patent Application Publication
(10) Pub. No.: US 2023/0285122 A1
(43) Pub. Date: Sep. 14, 2023

(54) TRANSFER PART, INSERTION TOOL, OR IMPRESSION POST FOR DENTAL IMPLANT WITH QUICK RELEASE MECHANISM

(71) Applicant: RUETSCHI TECHNOLOGY SA, Muntelier (CH)

(72) Inventors: Christoph RUETSCHI, Murten (CH); David CHENAUX, Corcelles (CH)

(21) Appl. No.: 18/017,984

(22) PCT Filed: Mar. 16, 2021
(86) PCT No.: PCT/IB2021/052173

§ 371 Date: Jan. 25, 2023

(30) Foreign Application Priority Data
Jul. 27, 2020 (EP) 20187968.1

(51) Int. Cl. A61C 8/00

(52) U.S. Cl. CPC A61C 8/0089; A61C 8/0001

(57) ABSTRACT

A transfer part for removable attachment and handling of a dental implant, the transfer part including a body portion having a longitudinal axis and including a traversing hole along the longitudinal axis, a center portion arranged in the traversing hole of the body portion, and a fastening mechanism for reversibly securing the transfer part to the dental implant, wherein the center portion and the body portion are configured for a relative motion between each other to switch from a first position to a second position and vice versa, wherein in the first position, the fastening mechanism is in a released state to allow a removal of the transfer part from the dental implant, and in the second position, the fastening mechanism is in an engaged state to allow a securing of the transfer part to the dental implant.

### CROSS-REFERENCE TO RELATED APPLICATIONS

The present invention claims priority to European Patent Application No. EP20187968.1 that was filed on Jul. 27, 2020, this document being herewith incorporated by reference in its entirety.

### FIELD OF THE INVENTION

The present invention relates to a holding piece, transfer part, impression post, impression coping, or insertion tool or other device for handling a medical implant, in particular a dental implant, for example threaded dental implants or other types of dental implants or artificial teeth. In addition, the invention relates to an element that can be used in conjunction with a dental fixture or bone anchor having a quick fasten-and-release mechanism.

### BACKGROUND

In the field of dental implants and corresponding systems and tools, dental implants and the corresponding bone anchors or bone fixtures are usually provided to a place of dental surgery in a sterile packaging, as surfaces of these elements are easily contaminated by organic or inorganic contaminants, and surface cleanliness is important for implant osseo-integration. Also, these elements are also very sensitive to abrasion as result of contact with other surfaces. This is accentuated by subjecting the packaged dental implants to vibrations and shock during transportation. The surface of these implants, particularly those parts of the implant which will, in use, be positioned within the bone, herein referred to as bone anchors or bone fixtures, can also be treated to enhance tissue adhesion and bone integration. Such treated surfaces are very sensitive to abrasion or deterioration when placed in contact with other surfaces, and can also suffer contamination. In addition, the bone-integration outer surface of the bone anchor of the dental implant can have fragile porous and jagged surfaces for improving the bone integration to the jaw bone.

To minimize contamination and also abrasion and other degrading effects to the surface and structure of the bone anchor or fixture by contact, implant packaging exists in which the dental implants can be firmly attached to the packaging for transportation and storage. For handling, transportation, removal from packaging, initial jaw bone hole placement, insertion, and attachment, the bone anchor or fixture of a dental implant can be temporarily fixed to a so-called holding piece, transfer part, or insertion tool. Some of these packaging for dental implants and other implants allow to hold the bone anchor or fixture substantially arranged inside a packaging wall, while the removable transfer part can be grasped by a user via a cavity in the packaging, for example with two fingers of a dental surgeon or operator, or by the use of an instrument, for example but not limited to a screwdriver, ratchet, tweezer, plier, handpiece.

For example, U.S. Pat. No. 8,864,494, this reference herewith incorporated by reference in its entirety, describes a holding piece 1 for a dental implant having a tool retention means adapted to cooperate directly with an insertion tool. The first end 10 of holding piece 1 is intended to be connected to a dental implant 25, and has four resilient elements in form of four flexible arms 45 extending parallel to the longitudinal axis 5. These arms 45 are bendable towards and away from the longitudinal axis 5, and are intended to be inserted inside a blind bore 50 of the dental implant 25. Near the distal end of each of the arms 45 is a snap catch 55 intended to form a snap connection with the internal connection of the implant 25.

Similarly, U.S. Pat. No. 9,468,507, this reference herewith incorporated by reference in its entirety, describes an insertion tool 2 for a dental implant, having a dental implant retention element 39, comprising two identically formed longitudinal dental implant retention arms 40a. 40b, extends to the apical end S. The dental implant retention arms 40a, 40 are separated from each other by a longitudinal slit 42 having an axis coinciding with the longitudinal axis L of the insertion tool 2. In use, the insertion tool 2 is brought into engagement with a dental implant 100 by inserting insertion tool 2 into the implant bore 101. The resilient dental implant retention arms 40a, 40b are thereby compressed inwardly and thereafter contact and press outwardly against the internal wall of the implant bore 101, which creates a press or interference fit between the dental implant 100 and the insertion tool

As discussed above, most of the existing solutions for attaching transfer parts or insertion tools for dental implants rely on a screwable attachment or passive elastic arms, for example two or more retention arms able to provide for a snap connection, for the removable attachment of the transfer part to the dental implant. However, it has been shown that this type of attachment is not secure for transportation, for example transportation of the dental implant and transfer part in a sterile packaging that is subject to vibration or shocks, and that often the transfer part is detached from the dental implant when arriving at a place of dental surgery, for example at the dental practice or dentist. To prevent this, at least some dental implant packaging require an additional component for attachment, for example a spring or a sleeve that is in contact with the implant. The snap connection discussed above usually provides for insufficient retention force, and also inconsistent force among different transfer parts for safe attachment Also, as a result of the inadvertent detachment, for example by knocking it off during a surgical procedure, the transfer part can get lost. The inadvertent detachment and subsequent contact with packaging walls can cause contamination of the dental implant, and can also cause damage to the fragile bone integration structures of the bone anchor or bone fixture.

Moreover, during a dental surgery itself, it is possible that the transfer part is knocked off or otherwise inadvertently removed from the dental implant, leading to problems of contamination, necessity of recovery of the dental implant, transfer part, or both within the mouth cavity of the patient or living being that is subject to a tooth restoration surgery with a dental implant, and the requisite reinsertion of the transfer part to the dental implant, which can be difficult.

Other types of transfer parts are attached to the bone anchor, implant post or fixture by a threading that can engage with a corresponding internal threading of the bone anchor, but these types of transfer parts may be difficult to release from the bone anchor, once bone anchor has been placed into a drill hole of a jaw bone, and can lead to a release of the bone anchor of the dental implant from the jaw bone itself. For example, to release the threadable engagement for removing the transfer part from the bone anchor, the manual rotational operation can be time consuming and difficult due to limited access.

For dental abutments that can be attached to a dental bone fixture, International Patent Publication No. WO 2014/185264 describes a dental implant 5 made of a fixture 10, a lock nut 50, a clamper pin 30, and a clamper 40. Unlike traditional dental abutments that are threadably attached to a fixture, the present one relies on comb teeth 41 of a clamper 40 that can deform to engage with a reverse tapered hole portion 15 inside fixture 10. Specifically, clamper pin 30 is equipped with an engagement part 31 that has tapered parts 31A, tapered parts 31A engaging with inner sides of comb teeth 41 of clamper 40 to spread comb teeth out, upon a threadable engagement of luck nut 50 with outer screw 32 of clamper pin 30, thereby operating like a collet chuck. The clamper 40 is thereby hooked at projecting portion 15A projecting to the inner peripheral side at the upper end of the reverse tapered hole portion 15 of the center hole 13 of the fixture 10.

However, this document is solely directed to a dental abutment 10 for implantation, but is not directed to any easy-removable or quick-release transfer part. For example, it is not clear whether abutment 10 can be removed, once comb teeth 41 are spread into reverse tapered hole portion 15. In addition, this type of dental abutment does not fit onto traditional dental fixtures or bone anchors, but requires a complicated and specially-machined center hole 13 of fixture 10, with reverse tapered hole portion 15.

In the field of dental impression posts or copings. U.S. Pat. No. 4,955,811 shows different types of conventional impression posts or copings, that can be threadably attached to a fixture, this reference herewith incorporated by reference in its entirety. Also, U.S. Pat. No. 7,066,736 describes an impression coping 10 that has a retention mechanism 38 that functions to hold the impression coping to the implant, having a biasing member 64 biases the locking member 62 against an internal surface or wall in bore 18 of the implant, this reference herewith incorporated by reference in its entirety, and U.S. Pat. No. 6,824,386 describes an impression post or coping 201, 301 that can be attached to an abutment 1, for example with abutment surrounding region 203 for seating on an abutment 1, having with an inner wall 207, 208, where abutment 1 is screw ably attached to fixture, this reference herewith incorporated by reference in its entirety.

In light of the above-described deficiencies of the state of the art for transfer parts, holding pieces, or insertion tools for dental anchors or fixtures, and impression posts and copings, there is a strong need to provide for substantially improved designs of transfer parts and other fast releasable parts for different aspects of dental surgery and dental prosthesis placing, having a secure but easily releasable attachment mechanism to the bone anchor of the dental implant, and having a simple and reliable design.

### SUMMARY

According to one aspect of the present invention, a transfer part, holding piece, or insertion tool for a dental implant is provided. Preferably, the transfer part, holding piece, or insertion tool for a dental implant includes a body portion having a longitudinal axis and including a traversing hole along the longitudinal axis, a center portion arranged in the traversing hole of the body portion, and a fastening mechanism for reversibly securing the transfer part to the dental implant. Moreover, preferably, the center portion and the body portion are configured for a relative motion between each other to switch from a first position to a second position and vice versa, wherein in the first position, the fastening mechanism is in a released state to allow a removal of the transfer part from the dental implant, and in the second position, the fastening mechanism is in an engaged state to allow a securing of the transfer part to the dental implant.

According to another aspect of the present invention, a dental implant system is provided, including a bone anchor or bone fixture and a transfer part that can releasable engage with the bone anchor or bone fixture. Moreover, preferably, the dental implant system includes a release tool for engaging with the transfer part for its release from the bone anchor or bone fixture.

According to still another aspect of the present invention, an impression post, pin, or coping, is provided, for removable attachment to a dental implant, for example to a fixture or a dental abutment. Preferably, the impression post includes a body portion having a longitudinal axis and including a traversing hole along the longitudinal axis, a center portion arranged in the traversing hole of the body portion, and a fastening mechanism for reversibly securing the transfer part to the dental implant. Moreover, preferably, the center portion and the body portion are configured for a relative linear motion between each other to switch from a first position to a second position and vice versa, wherein in the first position, the fastening mechanism is in a released state to allow a removal of the impression post from the dental implant, and in the second position, the fastening mechanism is in an engaged state to a allow a securing of the impression post to the dental implant.

Also, according to yet another aspect of the present invention, a method for forming an impression component is provided, by the use of one or more impression posts or copings having a release mechanism, that allows to remove one or more impression posts or copings from a dental fixture or dental abutment, after the impression component is formed, but preferably without the need for providing an access to impression post or coping via the impression material.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIGS. 1A to 1C show different exemplary views of the dental implant system 300 including a bone anchor or fixture 200 and a transfer part, holding piece, or insertion tool 100 according to one aspect of the present invention, with FIG. 1A showing a side view thereof, FIG. 1B showing a cross-sectional side view thereof showing body portion 10 having a traversing hole 80 centered along a central axis CA, center portion 20 extending along the traversing hole of body portion 10, and fixation, attachment, or fastening mechanism 30 arranged at the apical side of insertion tool 100, and FIG. 1C showing a cross-sectional view along line CSI in a viewing direction of the central axis CA, illustrating elements of the fastening mechanism 30;

FIGS. 2A to 2H show different exemplary views of transfer part, holding piece, or insertion tool 100 and the elements thereof, with FIG. 2A showing a top front perspective view of fastening mechanism 30 of transfer part 100 in a released, disengaged state showing a bolt 24 having a recess 28 where an engagement surface 22 is formed, and bendable device 12 in the form of a flexible lever that can flexibly and reversibly bend radially outwardly, bolt 24 being an apical-side extension of a center portion 20, and bendable device 12 being an apical-side extension of the body portion 10, FIG. 2B showing a side view of fastening mechanism 30 in the released, disengaged state. FIG. 2C showing a side perspective view of an exemplary transfer part 100, with center portion 20 installed into a traversing hole of body portion 100, FIG. 2D showing a top perspective view of body portion 10 without center portion 20, FIG. 2E showing a top perspective view of center portion 20 without body portion 10, center portion forming a shaft 25 along an axis of longitudinal extension CA, and having a nut or head 72 at a coronal side, and a recess 28 at the apical side, FIG. 2F showing a top front perspective view of fastening mechanism 30 of transfer part 100 in an engaged, expanded state where a part of bolt 24 can urge against bendable device 12 such that bendable device 12 can in turn urge radially outward to create pressing force PF to bone anchor 200, FIG. 2G showing a side view of the engaged, expanded state, and FIG. 2H showing an exemplary top perspective view of a transfer part 100 attached to bone anchor 200, with a release tool 90 engaging with a release tool or torque application tool engagement mechanism 70 of head 72.

FIGS. 3A and 3B showing alternative embodiments of the center portion 20 in a top perspective view and a cross-sectional view at bolt 24, having different types of engagement surfaces 122;

FIGS. 4A to 4C show different exemplary views of the dental implant system 401 including a bone anchor or fixture 200 and a transfer part, holding piece, or insertion tool 400 according to another embodiment, with FIG. 4A showing a side view thereof, FIG. 4B showing a cross-sectional side view thereof showing body portion 410 having a traversing hole 480, center portion 420 extending along the traversing hole 480 of body portion 410, and a fastening mechanism 430 arranged at the apical side of insertion tool 400, and FIG. 4C showing a close-up view of fastening mechanism 430, illustrating elements of the fastening mechanism 430 in an alternative embodiment,

FIGS. 5A-5F show different exemplary views of transfer part, holding piece, or insertion tool 400 and the elements thereof, according to this embodiment, with FIG. 5A showing a top-front perspective view of fastening mechanism 430 of transfer part 400 in a released, disengaged state showing a bolt 424 having a cylindrical recess 428 where a beveled circular edge 427 as an engagement surface is formed, and showing exemplary two bendable devices 412A, 412B in the form of a flexible protruding half-shells, bolt 424 being an apical-side extension of a center portion 420, and bendable devices 412A. 412B arranged facing each other radially, forming an apical-side extension of the body portion 410. FIG. 5B showing a side view of fastening mechanism 430 in the released disengaged state. FIG. 5C showing a top perspective view of body portion 410 without center portion 420. FIG. 5D showing a top perspective view of center portion 420 without body portion 410, center portion forming a shaft 425 along an axis of longitudinal extension CA, and having a nut or head 472 at a coronal side, and a cylindrical recess 428 at the apical side. FIG. 5E showing a top-front perspective view of fastening mechanism 430 of transfer part 400 in an expanded, engaged state showing bendable devices 412A, 412B radially bent outwardly to create pressing forces PF1, PF2, and FIG. 5F showing a side view of fastening mechanism 430 of transfer part 400 in the expanded, engaged state;

FIGS. 6A to 6F show different exemplary side views of an impression post, pin, or coping 500 that can be used for taking a dental impression with impression coping techniques, and show views of different steps of a method for impression taking, with FIG. 6A showing a step where an impression post or coping 500 having a fasten-and-release mechanism 430 is inserted into fixture or bone anchor 200 already placed to jaw bone JB, FIG. 6B showing a step where fasten-and-release mechanism 430 is fully inserted into blind bore or fixation opening 280 of jaw bone anchor or fixture 200, FIG. 6C showing a step where fasten-and-release mechanism 430 is fastened or engaged to fixture 200 by applying a linear force F1, FIG. 6D shows a step where the impression material 600 is formed around impression material engaging element 572 and a body portion 510 of impression post 500, FIG. 6E shows a step where the impression material 600 is solidified to an impression component 601 and pulled by a linear force F2 to disengage or release fasten-and-release mechanism 430 from fixture 200, by moving impression material 600 by a release distance RD, and FIG. 6F showing the release of the impression post or coping 500 and impression component 601 from the fixture 200, according to another aspect of the present invention.

Herein, identical reference numerals are used, where possible, to designate identical elements that are common to the figures. Also, the images are simplified for illustration purposes and may not be depicted to scale.

### DETAILED DESCRIPTION OF THE SEVERAL EMBODIMENTS

According to one aspect of the present invention, a dental implant system 300 is provided including a bone anchor or fixture 200 and a transfer part, holding piece, or insertion tool 100. According to another aspect of the present invention, a corresponding transfer part, holding piece, or insertion tool 100 is provided. For example, dental implant system 300 can include other elements such as but not limited to abutments, crowns, attachment screws, attachment tools such as but not limited to torque wrenches, ratchets, torque drivers, screw drivers.

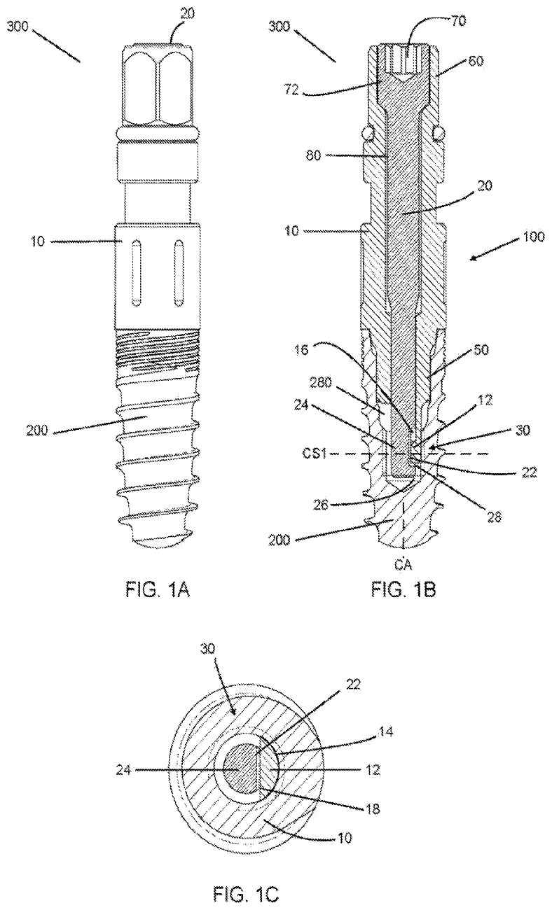

FIGS. 1A to 1C show different exemplary views of the dental implant system 300 including a bone anchor or fixture 200 having a slightly conical threaded bone engagement part, that is removably attached to a transfer part 100. However, other bone anchors 200 can also be used in conjunction with the herein presented transfer part 100, for example bone anchors 200 with non-threadable or expandable engagement with jaw bone JB, for example as shown in European patent application number EP20184074.1. FIG. 1A shows a side view of bone anchor 200 and transfer part 100 inserted thereto, FIG. 1B showing a cross-sectional side view thereof along a cross-sectional surface that traverses the central axis or longitudinal axis of extension CA of bone anchor 200, showing body portion 10 having a traversing hole, the traversing hole 80 having a rotational center that substantially coincides with center axis CA, showing a center portion 20 extending along the traversing hole of body portion 10 in the form of a longitudinal device that can be turned inside traversing hole 80, and a quick fasten-and-release mechanism or fastening mechanism 30 arranged at the apical side of insertion tool 100, for example configured as a quick release mechanism. FIG. 1C showing a cross-sectional view along line CSI in a viewing direction of the central axis CA, illustrating elements of the fastening mechanism 30. In the context of this specification, the terminology transfer part, holding piece, or insertion tool 100 are interchangeably used for reference numeral 100.

As indicated above, transfer part 100 is a mechanical element that is used for handling, transportation, removal from packaging, initial jaw bone JB hole placement, and jaw bone JB hole insertion, as well as for transferring torque to the jaw bone anchor 200 when using a torque tool to screwably and threadably attach jaw bone anchor 200 to jaw bone JB. Thereby, it is possible to manually hold a bone anchor 200 via transfer part 100, such that user or operator need to actually touch bone anchor 200 itself. In this respect, transfer part 100 is not an implantable part of dental implant system 300 and does not remain at the implantation location of the living being. Also, transfer part 100 does not need to include a dental abutment or other device or arrangement that is configured to engage with a crown. As an exemplary operation, user or operator can hold bone anchor 200 with transfer part 100, to take it out of the sterile packaging, applying some bone graft, and placing bone anchor 200 into a drill hole DH of jaw bone JB, and thereby never touch jaw bone anchor 200 with his hands. Once bone anchor 200 is placed to drill hole DH, transfer part 100 can also be used to apply tightening torque drive tool engagement section 60, for screwable attachment to jaw bone JB. Thereafter, transfer part 100 can be removed from bone anchor 200 by a simple manual operation as described below, or by the use of a release tool. Generally, a force or torque necessary for attaching and releasing transfer part 100 from bone anchor 200 is substantially lower than tightening torques that are applied to bone anchor 200 for final positioning and fastening with jaw bone JB.

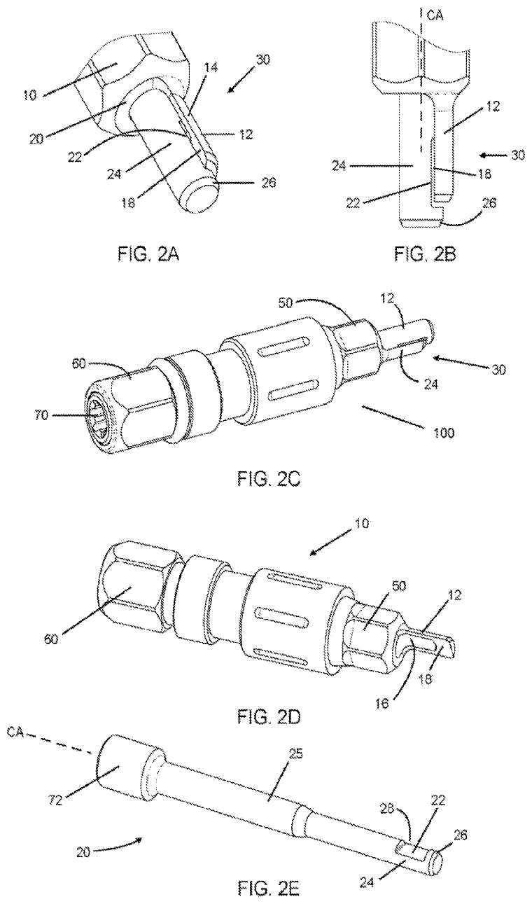

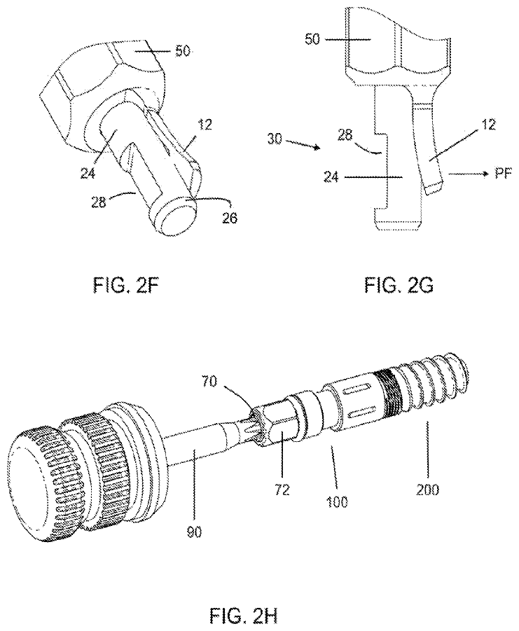

FIGS. 2A to 2E show different exemplary views of transfer part 100 and the different elements thereof, specifically more detailed views of fasting mechanism 30, with FIG. 2A showing a front perspective view of fastening mechanism 30 of transfer part 100 arranged at an apical side, showing a bolt 24 having a recess 28, where an engagement surface 22 is formed at a bottom of recess 28, and showing an reversibly and resiliently bendable or deflectable device 12 in the form of a flexible lever that protrudes in a direction parallel to center axis CA towards the apical side from body portion 10. In this variant, bolt 24 forms an apical-side extension of a center portion 20. Also, in the variant shown, there is only one retention arm 12, but it is possible that there are two or more retention anus, arranged circularly around bolt 24. FIG. 2B shows a side view of fastening mechanism 30 showing the engagement surface 22 that is facing a corresponding engagement surface 18 of bendable device 12, in this relative position between body portion and center portion 20 having a gap therebetween. FIG. 2C showing a side perspective view of an exemplary transfer part 100, with center portion 20 installed into a traversing hole of body portion 100, FIG. 2D showing a top perspective view of body portion 10 without center portion 20 arranged in traversing opening 80, and FIG. 2E showing a top perspective view of center portion 20 without body portion 10, center portion forming a shaft 25 along an axis of longitudinal extension CA, and having a nut or head 72 at a coronal side, and a recess 28 at the apical side.

As shown in FIG. 1B and FIG. 2E, center portion 20 is shown, longitudinally extending along axis CA, having a substantially rotational-symmetric shape other than the recess 28 at bolt 24, including a shaft 25 having a cylindrical shape, a head or nut 72 arranged at the coronal end that can have a larger diameter than a diameter of shaft 25, head 72 accommodating a release tool or torque application tool engagement mechanism 70, for example but not limited to a hex socket, torx socket, XNZ socket, Philips socket. At the apical side, center portion 20 includes elements of a fastening mechanism 30, including a protruding bolt 24 that has a recess 28, recess 28 forming an engagement surface 22 as a bottom surface, arranged to be parallel to axis CA. In addition, at the apically-facing end or front tip of bolt 24, a circularly-surrounding beveled or oblique edge 26 is arranged. In the variant shown, center portion 20 has a decreasing diameter from the coronal side to the apical side, with head 72 having the widest diameter, and bolt 24 having the smallest diameter. This allows to insert center portion 20 to traversing hole 80 of body portion from the coronal side. Traversing hole 80 has a diameter that is slightly wider than at a corresponding location of center portion 20.

Moreover, as shown in FIG. 1B and FIG. 2D, body portion 10 that can accommodate center portion 20 is formed substantially as a cylindrically-shaped element around center axis CA, having a drive tool engagement section 60 for engagement with different types of manual or powered torque drive tools, for example but not limited to a hex bit structure, torx structure, XNZ structure, a torque applying section 50 configured to engage with a corresponding torque receiving section of blind bore or fixation opening 280 of bone anchor 200, for example a hex bit structure. Drive tool engagement section 60 is arranged to be accessible by the drive tool when transfer part 100 is attached to a bone anchor 200. For example, in the variant shown in FIG. 1A, drive tool engagement section 60 is arranged to be outside of the bone anchor 200, at the end of the coronal side. At the apical side, body portion 10 also includes elements of fastening mechanism 30, including bendable device 12 formed as a protruding extension of body portion 10, forming a elastically flexible lever that can reversibly flex radially away from center axis CA, having an engagement surface 18 for engaging with the corresponding engagement surface 22 of bolt 24, and having a recess or opening 16 for accommodating a portion of bolt 24.

As shown in FIGS. 1B and 2C, center portion 20 and body portion 10 are configured such that center portion 20 can be inserted and pushed into traversing hole 80 of body portion 10 from the coronal side opening, and once bolt 24 on apical side reaches bendable device 12, center portion 20 is then snapped-in, snapped-locked or clipped to body portion 10 by using oblique edge 26 of bolt 24 as a push mechanism to radially and outwardly push bendable device 12 away from center axis CA, once bolt 24 arrives at an end of recess or opening 16 of bendable device 12. This allows front tip of bolt 24 and oblique edge 26 to pass front tip of bendable device 12. Thereafter, bendable device 12 flexes back towards center axis CA to its initial, neutral, or rest position, to lie within opening 28 of bolt 24. With this snap-in or snap-lock mechanism, center portion 20 is firmly installed inside body portion 10, substantially within traversing hole 80, whilst bolt 24 protrudes at an apical side or front end of body portion 10, with a simple mechanical design, only requiring two different elements.

Next, the operation of fastening mechanism or quick release mechanism 30 is described. Once center portion 20 is installed to body portion 10, center portion 20 is movable relative to body portion 10 from a first unlocked or disengaged position to a second locked or engaged position of fastening mechanism 30, and vice versa. In the variant shown, center portion 20 can be turned around center axis CA relative to body portion 10 by a certain angle from a first angular position to a second angular position, and vice versa. In the first angular position of center portion 20 relative to body portion 10, exemplarily shown in FIGS. 2A and 2B, engagement surface 22 of bolt 24 does not urge against corresponding engagement surface 18 of bendable device 12, and therefore bendable device 12 in a relaxed position, extending parallel to central axis CA. As shown in FIGS. 1B and 1C, in this first position, cylindrical outer surface 14 of bendable device 12 therefore does not exert any or only very little force against an inner wall of bore 280 of bone anchor 200, and therefore, transfer part 100 can be easily removed from bone anchor by pulling transfer part 100 away from bone anchor 200 in a coronal direction along central axis CA, and can also be inserted to bone anchor 200 in an apical direction along central axis CA. In other words, in the first position, center portion 20 is configured to disengage from or release fastening mechanism 30 to allow a removal and insertion of transfer part 100 form or to bone anchor 200.

To secure or fasten transfer part 100 to bone anchor 200 of a dental implant system 300, center portion 20 is turned around center axis CA relative to body portion 10 by a certain angle from a first angular position to a second angular position. In the variant shown, the turning can be clockwise or counterclockwise. For example, it is possible that center portion 20 is turned above 45° or more relative to body portion 10, for example by 90°, so that engagement surface 22 of bolt 24 engages with engagement surface 18 of bendable device element 12, so that bendable device 12 is urged outwardly in a radial direction away from center axis CA, and in turn outer engagement surface 14 of bendable device 12 will press against inner wall of bone anchor 200, as shown in FIGS. 2F and 2G. For example, outer surface 14 of bendable device 12 can urge against inner wall of bore 280 of bone anchor 200 at a location of an attachment threading for an attachment screw for dental abutment, with the rough surface of the threading providing for additional resistance to a removal of transfer part 100 in the second position. In this respect, a rotational torque applied to center portion 20 relative to body portion 10 will translate into a pressing force PF of bendable device 12 towards inner wall of bore 280 of bone anchor 200, or another part of bone anchor 200. This pressing force PF is configured to securely attach transfer part 100 to bone anchor 200 in this second position, applying a force of about 5 N or more.

In addition, bolt 24 itself can also bend outwardly in a second radial direction that is opposite to the radial direction of the bending of bendable element 12 towards inner wall of bore 280, by the transition from the first position to the second position, and a surface of bolt 24 can also urge an apply a second pressing force PF to inner wall of bore 280 of bone anchor 200, for example an edge right at oblique edge 26, to provide for an additional retention force to reversibly secure transfer part 100 to bone anchor 200. In this respect, in the engaged or secured state, bendable element 12 provides a first releasable retention or pressing force while bolt 24 can provide for a second releasable retention or pressing force that is arranged substantially opposite in a direction and axi-symmetric around axis CA to first pressing force PF for retention of transfer part 100 to anchor 200.

To return back to the first position, in the variant shown, center portion 20 is turned back an angle relative to body portion 10 until engagement surface 22 of bolt 24 disengages or releases from engagement surface 18 of bendable device element 12, so that bendable device 12 reverts back inwardly in a radial direction towards center axis CA, and in turn outer engagement surface 14 of bendable device 12 will disengage or release from inner wall of bone anchor 200. This is possible by bendable element 12 being flexible and reverting back to an initial, neutral, or rest position, extending substantially parallel to central axis CA. In this respect, a thickness of a wall of bendable element 12 at a location of recess or opening 16 can be made such that an outward an reversible bending can occur with a force of about 2 N or more.

The turning of center portion 20 relative to body portion 10 to switch back and forth from first position to second position can be configured to require a torque in a range of 10 Ncm to 100 Ncm, more preferable in a range between 5 Ncm to 50 Ncm, and can be done manually or by the use of a release tool 90 that can removably engage with release tool or torque application tool engagement mechanism 70 of head 72 as shown in FIG. 2H, or by a manual turning engagement with an extension of center portion 20 on the coronal side that protrudes from body 10, for example a device that is configured for manual engagement and turning, for example but not limited to a coronal-side element such as a knob, dial, dented wheel, lever, handle, bolt, plate. Release tool 90 can be embodied in different ways, for example but not limited to a screw driver, mirror, tweezer, probe, handle, bolt, dial.

The torque for releasing transfer part 100 can also be designed such that it is smaller than an attachment torque of jaw bone anchor 200 to drill hole of jaw bone JB that is typically in a range between 30 Ncm and 50 Ncm. As another aspect, transfer part 100 and fastening mechanism 30 can be configured such that a rotation of center portion 20 relative to body portion 10 for releasing transfer part 100, in other words to switch from the second position to the first position, is in a rotational direction that is the same as the attachment torque of bone anchor 200 to jaw bone IB for the threadable engagement. This allows to release transfer part 100 from bone anchor 200 in a rotational direction that does attempt to release bone anchor 200 from jaw bone JB, and in light of a release torque to switch from the second to the first position being lower than an attachment torque of bone anchor 200, does not add additional tightening torque of bone anchor 200 to jaw bone when releasing transfer part 100. Typically, an attachment torque for threadable engagement of bone anchor 200 with drill hole of jaw bone would be applied in a clockwise rotational direction, so fastening mechanism 30 is configured such that a rotation or turning of center portion 20 for releasing transfer part 100 from bone anchor 200 would also be in a clockwise rotational direction.

In the variant shown, outer engagement surface 14 is cylindrically-shaped with a radius or curvature to substantially match a curvature of blind bore 280 of bone anchor 200. In a variant, it is also possible that outer surface 14 that engages with bone anchor 200 includes structures to increase a retention force of transfer part 100 to bone anchor 200, for example but not limited to one or more ridges that are arranged substantially perpendicular to central axis CA, knobbed surface, retention ramps or saw-tooth structure, or can include a soft coating for increasing a retention force.

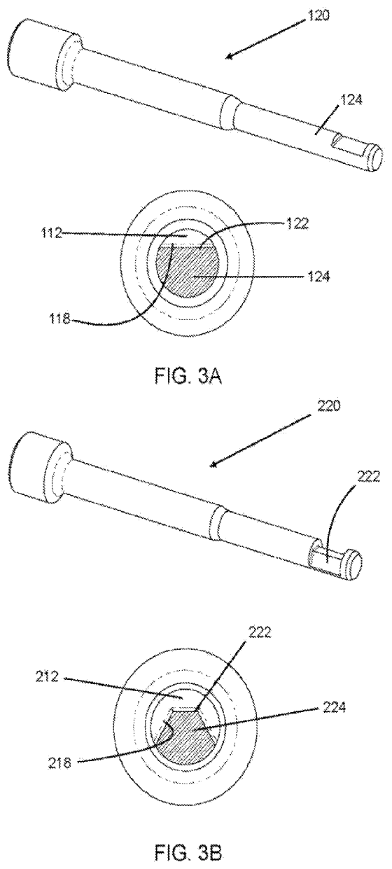

FIGS. 3A and 3B show alternative embodiments for the configuration of bolt 124, 224 of center portion 120, 220 and the engagement surface 122, 222 of body portion 110, 210, for example FIG. 3A showing a bolt 124 having a cylindrical diameter that is slightly smaller than a diameter of blind bore 280 of bone anchor 200, and bendable element 112 having substantially the same diameter. With engagement of engagement surface 122 of bolt 124 and engagement surface 118 of bendable element 112, both outer cylindrical surfaces of bolt 124 and outer cylindrical surface of bendable element 112 can both urge against inner walls of blind bore 280 of bone anchor 200, for a more reliable mechanical fastening. This requires bolt 124 is capable of radially bending outwardly away from axis CA when center portion 120 is turned from the first to the second position.

FIG. 3B shows a variant where engagement surfaces 222 of bolt 224 and engagement surface 218 of reversibly bendable element 212 include several surfaces having different angular orientations towards each other, in the variant shown three (3) different surfaces. As another variant, it is possible that engagement surface 22 forms an eccentric cam lobe surface for progressive application of an increased a pressing force PF with bendable device to inner wall of bone anchor 200. As another variant, surface 22 of bolt 24 could form a cylindrically-shaped threading that can threadably engage with a corresponding conically-shaped threading at inner surface 18 of one or more bendable elements 12, such that a threadable engagement of the cylindrically-shaped threading with the conically-shaped threading will advance the bolt 24 to expand the bendable elements 12 to provide for the pressing force PF. In a variant, bendable element 12 has a threading and is in an inwardly slanted position to be bent outwardly upon a threadable engagement with bolt 24, to thereby establish pressing force PF. In this respect, the transition from the first, unlocked position to the second, locked position and vice versa is done by a combination of a threadable engagement of center portion 20 with body portion 10, being combined rotational movement around central axis CA, and a linear translation movement in a direction of central axis CA.

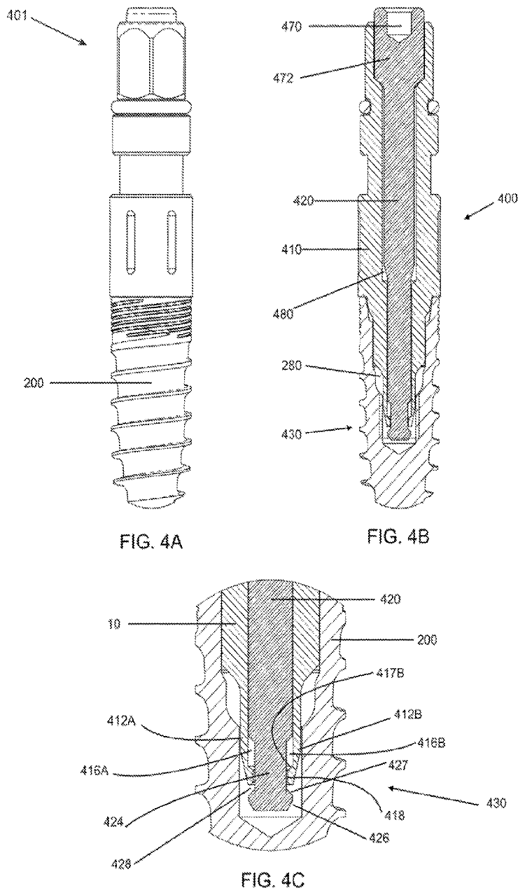

FIGS. 4A to 4C show different exemplary views of another embodiment of the herein presented dental implant system 500 including a bone anchor or fixture 200 and a transfer part, holding piece, or insertion tool 400, in which the engagement and disengagement of fastening mechanism 430 of transfer part 400 includes a linear motion of the center portion 420 relative to body portion 410 in both directions along axis CA to two move back and forth from the first position to the second position, where in the variant shown, a transfer from the first position to the second position causes an urging of a circular beveled edge 427 at a tip of bolt 424 against one or more a corresponding edges 418A, 418B of retention arms 412A, 412B, such that retention arms 412A, 412B are pressed radially outwardly against an inner wall of blind bore 280 of dental implant 200. FIG. 4A showing a side view of this embodiment showing dental implant system 500, FIG. 4B showing a cross-sectional side view thereof showing body portion 410 having a traversing hole 480, center portion 420 extending along the traversing hole 480 of body portion 410, and a fastening mechanism 430 arranged at the apical side of insertion tool 400, and FIG. 4C showing a close-up view of fastening mechanism 430, illustrating elements of the fastening mechanism 430. In the variant shown, retention arms 412A, 412B are made of hollow cylindrical shells having a cavity 416A. 416B formed therein, providing for die requisite elastic flexibility for radial expansion and contraction, separate by a slit or gap. Exemplarily, two (2) retention arms 412A, 412B are shown, but there could be only one retention arm, or more than two (2) retention arms, for example for (4) or another number of bendable retention arms 412, arranged equi-angularly around bolt 424.

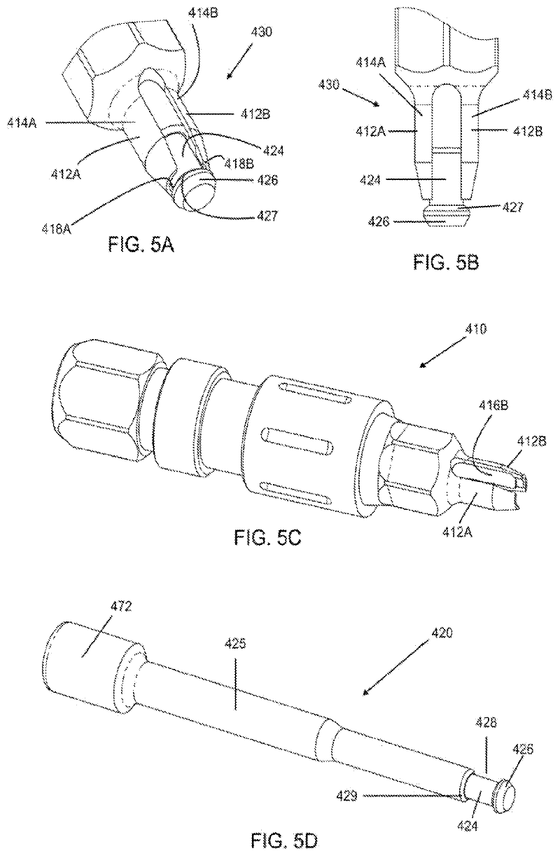

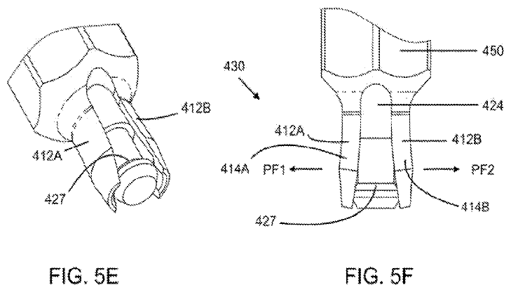

FIGS. 5A to 3F show different exemplary views of transfer part 400 with the two exemplary retention arms or bendable devices 412A. 412B. For example. FIG. 5A shows a top-front perspective view of fastening mechanism 430 of transfer part 400 in a relaxed or disengaged state showing a bolt 424 having a cylindrical recess 428 where a beveled circular edge 427 as an engagement surface is formed, and also showing exemplary two bendable devices or retention arms 412A, 412B in the form of a flexible protruding half-shells, bolt 424 being an apical-side extension of a center portion 420, and bendable devices 412A. 412B arranged facing each other radially opposite to each other, forming an apical-side extension of the body portion 410. FIG. 5B shows aside view of fastening mechanism 430 with the two exemplary retention arms 412A, 412B shown in a relaxed or disengaged state, FIG. 5C showing a top perspective view of an exemplary body portion 410 without center portion 420, FIG. 5D showing a top perspective view of an exemplary center portion 420 without body portion 410, center portion 420 forming a shaft 425 along an axis of longitudinal extension CA, and having a nut or head 472 at a coronal side, and a cylindrical recess 428 at the apical side around bolt 424, with a tip portion at the apical side having beveled circular edge 427. FIG. 5E shows a top-front perspective view of fastening mechanism 430 of transfer part 400 in an expanded, engaged state showing bendable devices 412A, 412B radially bent outwardly towards an inner wall of bone anchor 200 (not shown in this picture) to create symmetrically-opposing pressing forces PF1, PF2 that can engage with an inner wall of bone anchor 200, and FIG. 5F showing a side view of fastening mechanism 430 of transfer part 400 in the expanded or engaged state.

Nut or head 472 at the coronal side of center portion 420 can also be made to protrude outside of coronal side of body portion 410, so that a user or operator can manually engage therewith, for example by the use of two fingers to linearly pull or push center portion 420 relative to body portion 410 along axis CA, to switch transfer part 400 from the expanded, engaged state to the relaxed or disengaged state and vice versa. For example, head 472 can be formed as a ribbed cylinder having circular grooves or ridges, a tab having knobs to increase friction, a handle, a lever, a ring, or other implementations for manual engagement. Thereby, head 472 can form a means for manual engagement by the user or operator with his fingers, exposed from body portion 410, to switch between the two positions, and allowing for manual engagement by user or operator regardless of whether transfer part 400 is in the expanded, engaged state to the relaxed or disengaged state.

To assemble the transfer part 400, center portion 420 can be inserted to body portion 410 via traversing hole 480 for example by being manually pressed therein from the coronal side opening, and by the pressure or force caused to the apical side, the oblique circular edge 426 at the apical-side or front facing tip of bolt 424 presses both retention arms 412A, 412B radially outwardly, and after additional downward or apical-side linear movement of center portion 420 relative to body portion 410, tip of bolt 424 passes tips of retention arms 412A, 412B such that retention arms 412A, 412B revert back to a relaxed, rest or initial position, to be located and snap into cylindrical recess 428 that is formed around bolt 424. Thereby, center portion 420 is secured to body portion 410 by this snap-in or snap-lock mechanism.

Next, to switch fastening mechanism 430 from the first, relaxed, unlocked or disengaged position to the second, locked, expanded or engaged position, center portion 420 can be pulled upwardly relative to body portion 410, by a relative linear motion or displacement in a first direction, so that circular beveled edge 427 facing towards the coronal side of tip of bolt 424 engages with corresponding edges or surfaces 418A, 418B of retention arms 412A, 412B, and the upward pulling force will radially spread out retention arms 412A, 412B away from axis CA, as shown in FIGS. 5E and 5F. In turn, at least a portion of outer engagement surfaces 414A and 414B of the corresponding retention arms 412A, 412B will urge with pressing or retention forces PF1, PF2 against inner walls of blind bore 280 of bone anchor 200, for example with the arcuate edge that is formed at engagement surfaces 414A, 414B. Upon pushing down center portion 420 relative to body portion 410 by a relative linear displacement or motion in the opposite direction of the first direction, fastening mechanism returns to the first, unlocked position, where circular beveled edge 427 of the coronal side of tip of bolt 424 disengages from edges or surfaces 418A, 418B of corresponding retention arms 412A, 412B, and thereby outer engagement surfaces 414A and 414B of the corresponding retention arms 412A, 412B disengage retention or pressing forces PF1, PF2 from inner walls of blind bore 280 of bone anchor 200. In this first position, transfer part 400 can be removed from bone anchor 200 by a simple by a manual operation by pulling transfer part 400 in a direction along axis CA away from bone anchor 200, and can also be inserted to bone anchor 200 in the opposite direction. The switch from the second, locked position to the first, unlocked position therefore can require a simple manual push of center portion 420 at a coronal side thereof that protrudes from body portion 410.

In a variant, transfer part 400 can be released from bone anchor 200 by pulling center portion 420 relative to body portion 410 instead of pushing, to inverse a release direction of fastening mechanism 430 from the above described embodiment. In such variant, bolt 424 can be dimensioned such that a second circular beveled edge 429 located within cylindrical recess 428 can engage with edges 417A, 417B located inside cavities 416A. 416B, of corresponding retention arms 412A, 412B to spread apart retention arms 412A, 412B by a linear force in a direction towards the apical side on center portion 420, to switch from an first unlocked position to a second locked position. Thereafter, by pulling center portion 420, for example by a protruding portion or element at a coronal side thereof, linearly upwardly relative to body portion 410, it is possible to release pressure caused by second circular beveled edge 429 to edges 417A, 417B of corresponding retention arms 412A. 412B, to switch from the second, locked position to the first, unlocked position.

With the above-described embodiments, it is possible to provide for a simple and effective transfer part 100, 400, that is capable of providing a sufficient, durable, and easy-removable retention or attachment force to secure transfer part 100, 400 to a bone anchor 200, or other type of implant device, having an force that is sufficient to withstand shocks during transportation and handling of the dental implant during the surgical procedure when attaching the implant to a bone. During handling, it is not possible to easily knock off the transfer part 100, 400 from an anchor 200. In addition, the above described transfer part 100, 400 can be made solely from two different parts, the center portion 20, 120, 220, 420, and a corresponding body portion 10, 110, 210, 410, with the elements of the fastening mechanism 30, 430 integrated to the center portion and body portion, respectively, for example made of stainless steel, titanium-based material, or medical grade plastics, for example polyether ether ketone (PEEK), acetal copolymer (POM-C), polycarbonate (PC), providing for a cost-effective, simple and reliable solution for transporting and handling implants.

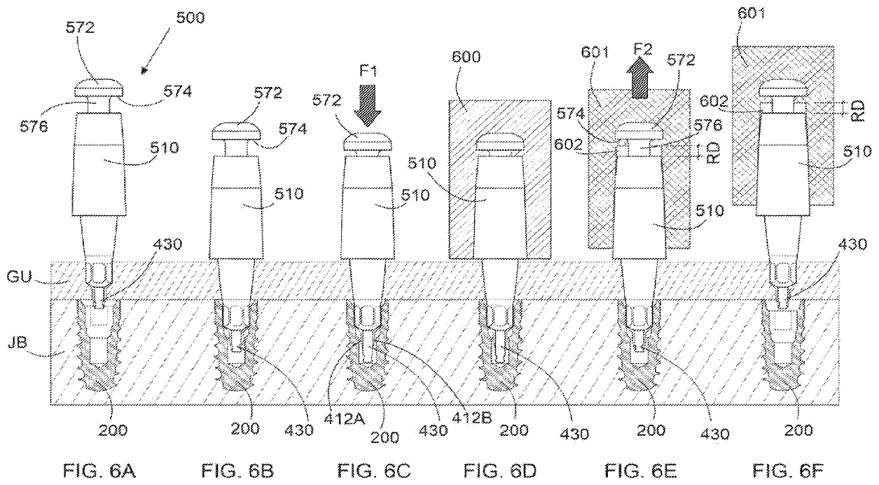

FIGS. 6A to 6F illustrate different aspect of the present invention, where an impression post or coping 500 is provided having the fasten-and-release mechanism 430 as described with respect to FIGS. 4A to 5F with the linear motion release principle for releasable attachment to bone anchor or fixture 200, serving a different application in the field of dental impression techniques, as compared to the transfer part 400. The different steps of a method for using impression post 500 are shown in FIGS. 6A to 6F for impression post insertion, impression taking or forming, and removal of impression component 601. In the example shown, an impression component 601 is formed onto only one impression post or coping 500, but it is also possible that several impression posts or copings 500 are attached to and related from the same impression component 601 by the same method. Also, in the variant shown, impression post or coping 500 is attached to a fixture 200, but it is also possible that the impression post or coping 500 is attached to another part of the dental implant, for example but not limited to a dental abutment, an intermediary element that can be threadably attached to a fixture.

In the background art of impression posts of copings, two different techniques are commonly used. In the open tray technique, bone anchors or fixtures 200 are not arranged parallel to each other to allow an impression to be taken from multiple impression posts or copings. To form the impression component, the impression tray is coated with adhesive and loaded with impression material 600, and impression material 600 is expressed around the impression posts or copings to capture the morphology of the soft tissue. The loaded impression tray is placed onto the exposed parts of the impression posts or copings, and the occlusal openings are swiped, scratched or otherwise removed to expose the occlusal aspect of the impression posts or copings, so their screws can be located before polymerization or other type of hardening of the impression material 600 occurs, thereby requiring an open tray. This allows to provide for the required openings or cavities to access the different impression posts for loosening from the dental anchors or fixtures 200.

In contrast thereto, the closed tray impression technique can used when the bone anchors or fixtures 200 are parallel enough to allow an impression to be withdrawn from multiple impression posts or copings, for example in situations with limited interarch distance and insufficient space for use of screw-retained impression posts or copings. An impression tray can be used in the fabrication of a closed tray impression for a fixed complete denture. Closed tray impression copings or post are placed on implants or multi-unit abutments and the impression made. Once the impression material polymerizes or otherwise hardens, the impression 600 is dislodged from the closed tray impression copings or posts. The closed tray impression copings or posts are then removed from fixtures 200 and implant or abutment analogs attached to the copings. The combined coping-analog assembly is then inserted into the definitive impression.

For both the open tray and the closed tray technique, the attachment of impression post or coping to fixture 200 is conventionally done by a threading at the apical side of the impression post or coping, or a simple clip at the apical side. For removal, the threading requires the use of a tool for releasing the threadable engagement, requiring multiple full rotations. In contrast thereto, the clip-based impression post or coping is removed by a simple pull, being prone to premature removal and inaccurate positioning. According to an aspect of the present invention, an impression post or coping 500 is provided, having a quick or rapid fasten-and-release mechanism 430, providing for several benefits over the existing solutions. Specifically, once the impression post or coping 500 is embedded into the impression material 600, impression posts 500 can be released from fixtures 200 by applying a linear force F2, without the need of a specific tool and specific access by a cavity, opening or recess in impression material 600, as required in the open tray technique. At the same time, with fasten-and-release mechanism 430, the retention force and connection reliability of impression posts 500 to fixture 200 can be substantially improved over the clip-based impression posts or copings of the background art, and also provide for a defined and stable positioning of impression posts 500 relative to fixture 200.

FIG. 6A showing a step where an impression post or coping 500 having a fasten-and-release mechanism 430 is inserted into fixture or bone anchor 200. Bone anchor 200 has been firmly attached to a drill hole DH in the jaw bone JB, with an access opening provided in the gum tissue GU. Impression post or coping 500 includes a body portion 510 with a portion thereof that is formed to engage but also to be slidably released from impression material 600, for example but not limited to a slightly conical shape with a narrowing diameter towards the coronal side or end, a cylindrical shape, an elliptic cylindrical shape, a curved cross-sectional shape with a progressively decreased diameter. In the variant shown, an outer surface of body portion 510 has a double conical shape with a larger apex angle towards impression material engaging element 572. Moreover, center portion 520 includes a impression material engaging element 572 at the coronal side or end, attached to a shaft 576 that is arranged within a central axis of center portion 520. In the variant shown, impression material engaging element 572 is formed as a knob having a retention surface 574. Also, a surface of body portion 510 can be shaped or can have coating or layer that allows to reduce adherence to impression material 600, for example by the use of a special non-bonding or non-stick coating. In a variant, it is also possible that surface of body portion 510 is at least temporarily coated with a paste-like material to prevent or reduce adhesion to impression material 600. After polymerization or hardening of the impression material 600, surface of body portion should provide for only a limited or no bonding between a surface of body portion 510 and impression material 600. Fasten-and-release mechanism 430 at the apical end is shown in the relaxed, non-engaging state.

Moreover, to prevent, reduce, or resist to a relative rotation of body portion 510 to impression material 600 and component 601, different types of surface structurations, body shapes, and combinations thereof can be used for body portion 510 or for a portion thereof, whilst at the same time having the anti-adhesion characteristics or properties of the outer surface of body portion 510, so that body portion 510 can still easily detach in a direction of rotational axis from impression material 600 and component 601. In a variant, a cross-sectional shape of body portion when seen in a direction of the rotational axis can be triangular, quadrilateral, pentagonal, hexagonal, or other type of polygon shape, can be elliptic, oval, circularly arranged waveshape, and possibly at the same time being tapered towards the coronal side. Also, it is possible that body portion 510 has surface structurations, for example longitudinal grooves or ridges that are arranged to be in an axial direction on the outer surface, for example having soft or rounded edges to avoid additional adhesion properties to impression material 600, whilst preserving the anti-rotational properties.

Next. FIG. 6B shows a step where fasten-and-release mechanism 430 is fully inserted into blind bore or fixation opening 280 of fixture 200. In this position, torque applying section 450 configured to engage with a corresponding torque receiving section of blind bore or fixation opening 280 of bone anchor 200, to provide for a defined penetration depth and fixed positional relationship between impression post 500 and bone anchor 200. Fasten-and-release mechanism 430 is still in the relaxed, non-engaging state.

Thereafter, as shown in FIG. 6C, user or operator can press down release knob 572 by a linear force F1 such that the fasten-and-release mechanism 430 switches from the relaxed, non-engaging state, to the attached, engaged, or expanded state. This operation is explained above with respect to FIGS. 4C, 5E, and 5F, where center portion 520 moves towards the apical side relative to body portion 510 due to linear force F1, to spread out bendable devices 512A, 512B for engagement with bone anchor or fixture 200. This provides for a firm retention of impression post or coping 500 relative to fixture 200 that is fixated inside drill hole DH of bone anchor BA.

Next, FIG. 6D shows a step where the impression material 600 is formed around an attachment surface of a body portion 510 of impression post 500, for example by the use of an impression tray. In this step, impression material 600 can be pressed or otherwise provided around body portion 510 and release knob 572 of impression post or coping 500. Preferably, impression material 600 in its plastic state is pressed into the ring or toroid-shaped cavity forming a circular groove between disk-shaped retention surface 574 and the coronal side or end of the body portion 510. It is also possible that knob 572 is formed to have different types of undercut openings, cavities, or other structures to accommodate the plastically deformable impression material 600. Unlike in the background art open tray techniques, there is no need remove a part of the impression material 600 or to form openings or cavities in the impression material 600, as there is no need to provide for access to impression post or coping 500. Therefore, a closed tray can be used for providing the impression material.

FIG. 6E shows a step where the impression material 600 is solidified, for example but not limited to by polymerization, curing, or hardening, to form an impression component 601, and a release or removal of impression component 601 together with impression post or coping 500 from bone anchor or fixture 200. At this stage, user or operator can pull impression component 601 by a linear force F2 away from fixture 200, which leads to a disengagement or releasing of fasten-and-release mechanism 430 from fixture 200. At the same time, impression material 500 is moved and released from body portion 510 of post 500 by the linear motion with force F2 by a release distance RD, but with release knob 572 still firmly lodged into impression component 601. This is due to a firm engagement of impression material engaging element 572 and its retention surface 574 with hardened impression component 601, specifically by the material that has been formed to engage with retention surface 574, allowing to lock or retain impression material engaging element 572 inside impression component 601, and also the shape and surface of body portion 510, for example to be a slightly conical cylindrical shape, allowing body portion to dislodge, slip, slide, or otherwise detach from impression component 601. The moving of impression component 601 with impression material engaging element 572 relative to body portion 510 opens up a cavity 602 inside impression component, underneath surface 574 and a layer of impression material 600. No external access to impression material engaging element 572 is necessary for releasing impression post 500, for example via a cavity in the impression material 600, nor is any tool required to engage with impression material engaging element 572, for example shaped as a release knob or disk.

In the variant shown of FIG. 6E, force F2 has disengaged fasten-and-release mechanism 430 from fixture 200, and has permitted a linear displacement of impression component 601 by the distance RD relative to body portion 510 of impression post 500, while impression material engaging element 572 and center portion 420 has remained firmly engaged with impression component 601. Thereby, bendable devices 412A, 412B have been retracted radially inward and are no longer holding onto a side wall of bore of fixture 200, whilst shaft 425 of center portion 420 has moved towards the coronal side. While only one impression post and fixture pair 500, 200 is shown in this example, the pulling force F2 can permit a release of several impression posts or copings 500 simultaneously, so that the posts 500 can be removed from their respective fixtures 200, with impression component 601 attached to one or more impression posts or copings 500 can be removed away from fixtures 200. FIG. 6F shows the full release of the impression post 500 together with the impression component 601 from the fixture 200.

Even in the case where several impression posts 500 are attached to one impression component 601, and where the impression posts 500 are not arranged parallel to each other, in other words the angle of orientation of the different impression posts is different as compared to common reference frame, it is still possible to release the several impression posts 500 and impression component 601 from the several fixtures 200, for example aided by the conical shape of body portion 510, allowing for an exemplary angular range variation of about 15° between the axes of orientation CA of the different bone anchors or fixtures 200. Specifically, a conical shape or other tapered shape of body portion 510 that is slidably an releasably engaged with impression material 600 and the impression component 601 allows for a wider release angle departing from the rotational center axis of impression post 500. With respect to the shape of knob 572, this need not be a disk- or plate-like shape as exemplarily shown in FIGS. 6A to 6F, but can be another device that allows to firmly anchor the end of the central portion 420 inside the impression material 600, for example it can include and is not limited to a star shape, one or more levers or handles, a crown shape, a ring, cylinder, a sphere, a semispherical component, one or more hooks, or can have a specific surface structuring allowing for the firm anchoring, for example circular grooves and ridges around a cylindrical element, knobs, ramps, hooks, dents, or other types of protrusions, having a type of undercut shape.

With the herein presented features of impression post or coping 500, it is possible to combine the advantages of both the open tray and closed tray techniques, inasmuch one ore more impression posts are releasable from impression component 601 as it would be possible in the open tray technique where the impression posts are individually releasable from the fixture 200, via release mechanism accessed by one or more an cavity or opening in the impression material 600. However, at the same time, the herein presented impression post or coping 500 includes a fast release mechanisms that can be fully embedded into impression material 600 and does not need such access to a release mechanism from the outside of the impression component 601 via an open cavity or opening in the impression material 600, thereby allowing the molding of an impression component 601 with a closed tray. Another advantage of the herein presented impression post or coping 500 as compared to the closed tray technique is that the impression posts or copings 500 are never fully removed from impression component 601, as the impression material engaging element 572 retains posts or copings 500 securely attached to component 601. This allows to avoid a mixing up between several removed impression posts by the user or operator, for example the dental technician or dental surgeon.

The herein presented transfer parts 100, 400 and impression post 500 that are described in the context of a dental implant system, for removable attachment to a dental implant, for example bone anchor or fixture 200. However, the same transfer part 100, 400 with its attachment mechanism 30, 430 can also be used for attachment to other types of implants and bone screws. As non-limiting and non-exclusive examples, transfer part 100, 400 could be used for removable attachment to a spinal implant, bone screws for bone fixation plates, bone fixation plates for different bone fractures, for example mandibular and maxillofacial fractures, fixation rods.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A transfer part for removable attachment and handling of a dental implant, the transfer part comprising:
a body portion having a longitudinal axis and including a traversing hole along the longitudinal axis;
a center portion arranged in the traversing hole of the body portion; and
a fastening mechanism for reversibly securing the transfer part to the dental implant,
wherein the center portion and the body portion are configured for a relative motion between each other to switch from a first position to a second position and vice versa, wherein in the first position, the fastening mechanism is in a released state to allow a removal of the transfer part from the dental implant, and in the second position, the fastening mechanism is in an engaged state to a allow a securing of the transfer part to the dental implant.

2. The transfer part according to claim 1, wherein the body portion further includes:
a torque applying section configured to engage with a corresponding torque receiving section of the bone implant; and
a drive tool engagement section for engagement with a torque drive tool, the drive tool engagement section arranged to be accessible by the drive tool when the transfer part is attached to the bone implant.

3. The transfer part according to claim 1, wherein the relative motion from the first position to the second position and vice versa is a rotation motion.

4. The transfer part according to claim 1, wherein the fastening mechanism includes:
an engagement surface that is operatively connected to the center portion; and
a bendable device that is operatively connected to the body portion,
wherein upon the relative motion of the center portion relative to the body portion from the first position to the second position, the engagement surface is configured to urge against the bendable device, such that the bendable device is configured to press against the dental implant to secure the transfer part to the dental implant.

5. The transfer part according to claim 4, wherein the engagement surface includes a cam arranged at an apical side of the center portion, and the bendable device includes a retention arm that is arranged at an apical side of the body portion,
wherein the relative motion from the first position to the second position includes a rotation of the center portion relative to body portion, to urge the cam against the retention arm so that the retention arm is configured to press against a wall of the dental implant.

6. The transfer part according to claim 5, wherein the center portion includes a bolt arranged at the apical side having a cut-out surface in parallel to the longitudinal axis, the cut-out surface forming the cam, and the retention arm includes an outer surface configured to press against the dental implant.

7. The transfer part according to claim 4, wherein the center portion includes an oblique edge and a recess at the apical side, the oblique edge and the recess permitting a securing of the center portion in the traversing hole of the body portion, by radially extending the bendable device and snap-locking the center portion with a portion of the bendable device located in the recess, when center portion is inserted to the traversing hole.

8. The transfer part according to claim 4, wherein the engagement surface includes a beveled edge arranged at an apical side of the center portion, and the bendable device includes a retention arm that is arranged at an apical side of the body portion,
wherein the relative motion from the first position to the second position includes a linear motion of the center portion relative to body portion, to urge the beveled edge of against the retention arm so that the retention arm is configured to press against a wall of the dental implant.

9. The transfer part according to claim 8, wherein the center portion includes a head at a coronal side for manually applying the linear motion that moves the center portion relative to the body portion.

10. The transfer part according to claim 8, wherein the center portion includes a bolt arranged at the apical side having the beveled edge forming a circular conical structure around the bolt, where the retention arm includes one or more radially expandable levers configured to urge against the dental implant by a pressure caused by the beveled edge of the center portion upon the linear motion from the second position to the first position.

11. The transfer part according to claim 1, wherein the center portion further includes:
a head portion protruding from the body portion, the head portion configured for manual application of the relative motion between the center portion and the body portion.

12. The transfer part according to claim 1, wherein the center portion further includes:
a head portion protruding from the body portion, the head portion including a release tool engagement mechanism for applying the relative motion between the center portion to the body portion.

13. The transfer part according to claim 1, wherein the fastening mechanism includes:
a protrusion having a first threading arranged at an apical side of the center portion; and
a bendable device having a second threading arranged at an apical side of the body portion,
wherein the relative motion includes a threadable engagement of the first threading with the second threading, and the bendable device is configured such that the first threading urges against the bendable device to press against the dental implant to secure the transfer part to the dental implant.

14. The transfer part according to claim 13, wherein upon the relative motion of the center portion relative to the body portion from the first position to the second position, an apical side of the center portion is configured to bent and press against the dental implant to further secure the transfer part to the dental implant, as a result of the engagement surface urging against the bendable device.

15. A dental implant system comprising:
a bone anchor;
a transfer part that is removably attachable to the bone anchor and for handling the bone anchor, the transfer part being according to claim 1; and
a release tool for engaging with the transfer part for performing the relative motion.

16. An impression post for removable attachment to a dental implant, the impression post comprising:
a body portion having a longitudinal axis and including a traversing hole along the longitudinal axis;
a center portion arranged in the traversing hole of the body portion; and
a fastening mechanism for reversibly securing the transfer part to the dental implant,
wherein the center portion and the body portion are configured for a relative linear motion between each other to switch from a first position to a second position and vice versa, wherein in the first position, the fastening mechanism is in a released state to allow a removal of the impression post from the dental implant, and in the second position, the fastening mechanism is in an engaged state to a allow a securing of the impression post to the dental implant.

17. The impression post according to claim 16, wherein the fastening mechanism includes:
an engagement surface that is operatively connected to the center portion; and
a bendable device that is operatively connected to the body portion,
wherein upon the relative linear motion of the center portion relative to the body portion in a direction towards the apical side from the first position to the second position, the engagement surface is configured to urge against the bendable device, such that the bendable device is configured to press against the dental implant to secure the impression post to the dental implant.

18. The impression post according to claim 16, wherein the center portion includes an impression material engaging element arranged at a coronal side, the impression material engaging element configured for engaging with impression material in a plastic state, to provide for an anchoring of the center portion with the impression material.

19. The impression post according to claim 16, wherein the body portion includes a conical shape that us tapered towards a coronal side.

20. The impression post according to claim 18, wherein the body portion includes a surface that is configured to prevent adhesion to the impression material.

21. The impression post according to claim 16, wherein the body portion includes rotation blocking features that prevent or resist a rotation of body portion relative to impression material.
